(19) United States
(12) Patent Application Publication
(10) Pub. No.: US 2012/0111585 A1
(43) Pub. Date: May 10, 2012

(54) METHOD AND IMPLEMENT FOR CULTIVATING SOIL

(76) Inventor: Mark A. Patla, Somerset, NJ (US)

(21) Appl. No.: 12/943,063

(22) Filed: Nov. 10, 2010

(51) Int. Cl. A01B 79/00; A01B 1/22

(52) U.S. Cl. 172/1; 172/378

(57) ABSTRACT

A manually operated hand-held implement used for cutting into and through soil and soil barriers, facilitating the loosening and cultivating of soil in preparation of planting or seeding. An embodiment of the implement is comprised of an elongated vertical shaft with transverse handle at one end, a foot-pedal further down the shaft and a cultivating head comprised of a plurality of circumferential-spaced triangular blades formed in an arrowhead shape at the other lower end of the implement, terminating in a pointed tip. The arrowhead blade shape facilitates penetration of the implement into the soil, with the blade edges simultaneously severing soil barriers during penetration of soil. The operator may use the implement in a standing, kneeling or seated position and with a downward rocking, twisting and agitation motion of the implement, causing the arrowhead to penetrate, cultivate and prepare a soil hole for planting.

### BACKGROUND OF THE INVENTION

1. Field of the Invention

Embodiments of the present disclosure relate generally to a manually operated hand-held implement designed to pierce and cut through soil barriers and to cultivate and aerate soil in preparation for planting or seeding or generally grooming soil areas.

2. Discussion of Background

Prior to planting or seeding a garden or preparing a planting or soil area, one generally loosens or cultivates the soil. This cultivation action helps to better accommodate the deposit of plants or seed. Furthermore, the act of cultivating soil helps to improve drainage, encourages better soil aeration and allows plant roots and seed to penetrate and grow better. It has become common for gardeners to prepare planting areas with one or more soil barriers such as weed-block fabrics, mulch layers and the like, to help prevent garden weeds, as well as to add to the aesthetic beauty of the area. Roots and stones present in the soil can make up additional soil barriers. The presence of these “soil barriers” complicates the process of cultivating the soil. As an example, when cultivating an area that is covered by mulch, weed-block and root-laden soil, a person may have to kneel or bend to clear away the mulch layer thereby exposing the underlying weed-block fabric. The weed-block fabric must then be cut, scissored or chopped, producing a hole in the fabric exposing the underlying soil. The underlying soil must then be dug or cultivated using one of a number of currently available digging or cultivating implements. If the soil is root-laden the cultivation process may be further impeded. Finally, upon cultivation, the person would then be able to plant or seed the soil. Conversely, the invention would allow the user, from a comfortable standing, sitting or kneeling position, to thrust the implement into the ground, piercing the soil barriers and root-laden soil in one step and with a twisting action of the implement, cultivate and make the soil ready for planting.

Currently, devices designed to facilitate the cultivation of soil are known. However, such tools are ineffective when preparing areas containing soil barriers. Therefore, there is a need in the art for an implement to more efficiently prepare and cultivate soil as described.

### SUMMARY OF THE INVENTION

Embodiments of the present invention generally relate to a hand-held implement for penetrating soil barriers and cultivating soil. An object of this invention is to provide an implement that will allow the user to easily cut through soil barriers comprised of, but not limited to, mulch cover, weed-block fabric or similar materials, and/or dense, root-laden soil. Another object of this invention is to provide a soil cultivation implement for the rapid and efficient planting of plants, seedlings or seed. Other objects of this invention are to provide an implement that is simple in construction, inexpensive to manufacture, has no moving parts, is lightweight, is efficient, durable and easy to operate.

One embodiment of the invention incorporates an elongated vertical shaft with an affixed transverse mounted handle, a footrest affixed to the shaft and terminating in an arrowhead shaped blade configuration affixed to the shaft end consisting of a plurality of circumferential-spaced blades that form the arrowhead or cultivating-end of the implement, terminating in a generally pointed tip.

### BRIEF DESCRIPTION OF THE DRAWINGS

The accompanying drawings illustrate the invention, along with descriptive comments that serve to explain the principles behind the invention.

FIG. 1 is a perspective view of the implement, constructed in accordance with the present invention, generally described as the implement.

FIG. 2a is a segmented front view of the invention, detailing the upper, middle and lower portions of the implement.

FIG. 2b is an exploded view of the cultivating end of the implement with an arrow-shaped, circumferential-spaced multi-blade configuration, herein referred to as the arrowhead.

FIGS. 3a, 3b and 3c provide three perspective views of the implement, demonstrating possible order or method of use.

FIG. 4a depicts an alternative embodiment of the implement without a footrest.

FIG. 4b depicts an alternative embodiment of the implement without the transverse handle or footrest.

### DETAILED DESCRIPTION OF THE INVENTION

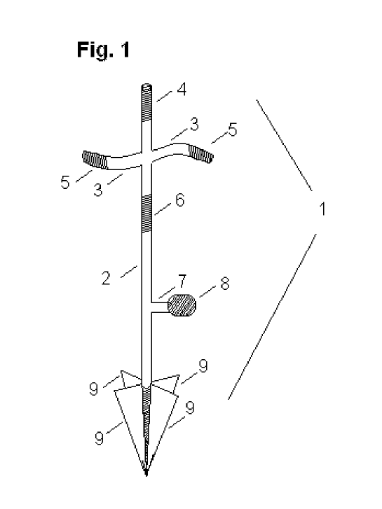

Shown in FIG. 1 is a perspective view of an implement 1, constructed in accordance with the principles of the present invention and designated generally as a cultivating implement. It is comprised of an elongated vertical shaft 2 having a hand grip 4 terminating at the top end of the shaft and a transverse handle 3 affixed to the shaft with hand grips 5 on either end of the transverse handle. An additional hand grip 6 is placed further down the shaft 2 with a lateral member 7 and footrest 8 affixed to the main shaft 2. A plurality of circumferential-spaced triangular-shaped blades 9 are affixed perpendicular to the main shaft 2, and culminate in an arrow-shaped configuration with the blades 9 terminating in a relatively sharp pointed tip. The combination of the sharp pointed tip and arrow-shaped wedge design aid the implement in penetrating and cutting through soil barriers.

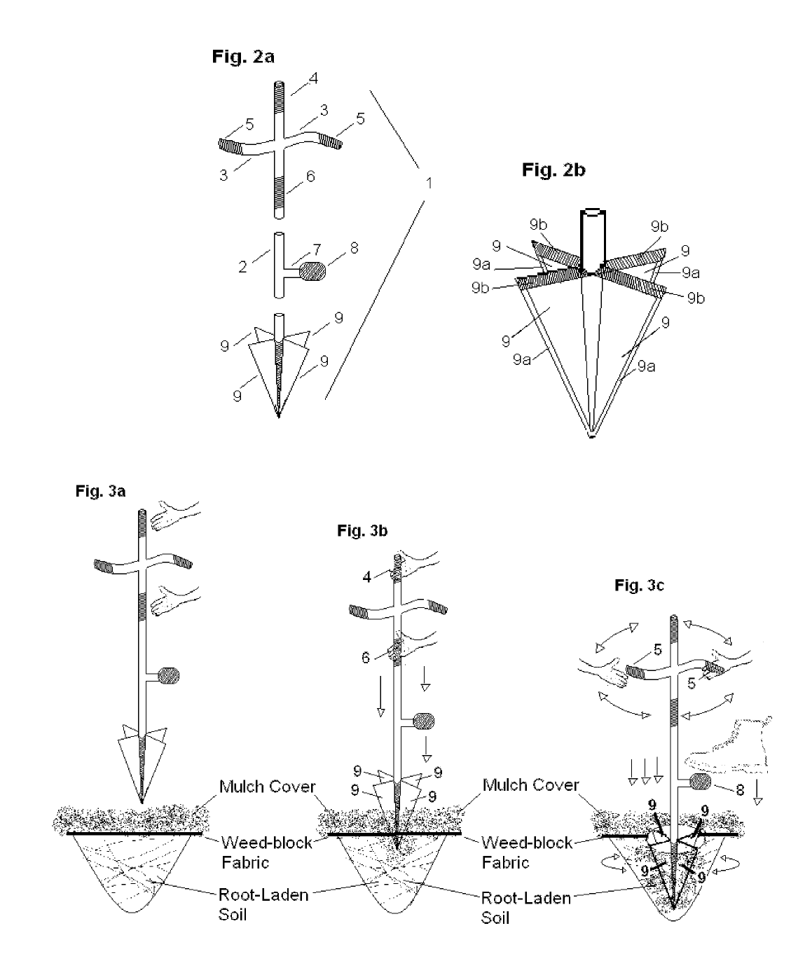

FIG. 2a provides a three-segment perspective view of the implement 1, the top end or segment of which is comprised of the main shaft 2, transverse handle 3 and hand grips 4,5 and 6. The varied, vertical and horizontal positioning of the hand grips enable an operator to use or work the implement in a variety of positions. By holding the implement at hand grips 4 and 6 the user can work the implement in a spearing or thrusting motion. Holding the implement by the hand grips 5 allows the user to exert downward force, and additional twisting, rotating and agitating of the implement to work or cultivate the soil from this grip position is achieved. The middle end or segment shows a lateral member 7 affixed to the main shaft 2. This lateral member 7 terminates in footrest 8 thus allowing the user to place a foot on the footrest 8 to exert significantly greater downward force on the implement, increasing the ease with which the implement penetrates soil barriers, hard or compacted soil. The bottom end or segment of the implement shows the arrowhead blades 9 establishing the cultivating end of the implement. This arrow-shaped design facilitates a cutting penetration of surface barriers or soil, while the broadening triangular angle of the blades 9 when fully inserted into the soil allow for deep and wide cultivation by twisting or agitating the implement at hand grips 4, 5, or 6.

FIG. 2b is an exploded view of the arrowhead blade portion of the implement. A plurality of circumferential-spaced triangular blades 9 are perpendicularly affixed to the main shaft 2 in a configuration that forms an arrowhead shape. The outermost portion of the blades 9a may be sharpened or serrated to enhance the implement cutting and severing capability. The top line of the blades 9b may be reinforced to provide extra blade strength and stability.

FIGS. 3a, 3b and 3c illustrate a succession of perspective views demonstrating possible ways to hold and/or use the implement when penetrating soil barriers.

FIG. 3a depicts a perspective view of the implement as prepared for use in cultivating an area of root-laden soil, covered with a weed-block and mulch barrier.

FIG. 3b illustrates a perspective view of the implement when hand-grasped at hand grips 4 and 6. Note the downward spearing or thrusting action of the implement as indicated by the downward facing arrows in the figure, the blades 9 penetrating the soil barriers, graphically depicted as layers of Mulch Cover, Weed-block Fabric and Root-laden Soil.

FIG. 3c illustrates a perspective view of the implement in use. In this instance the user has changed the hand position from grips 4 and 6 and re-positioned them at grips 5. This allows the user to easily apply downward hand pressure on the grips 5 while simultaneously twisting, rotating and/or agitating the implement, which in turn causes the arrowhead blades 9 to cut or sever the soil barriers to further penetrate, break up and cultivate the underlying soil. The lower segment of the implement shows the footrest 8 wherein the user demonstrates the application of additional downward foot force as may be required to pierce soil barriers thereby aiding deeper penetration into the soil.

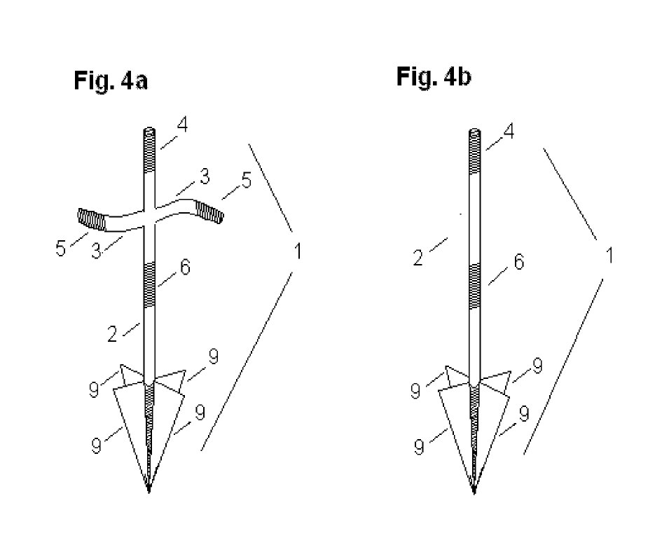

FIG. 4a depicts an embodiment of the implement 1, without FIG. 1 lateral member 7 and footrest 8.

FIG. 4b depict an embodiment of the implement 1, without FIG. 1 transverse handle 3, grips 5, lateral member 7 and footrest 8.

It is envisioned that the implement may be produced in a variety of sizes with various options i.e. the use of handles, padded grips, footrest and the like, to meet the needs of the job to be performed. Variations of the implement may range in size from perhaps 12″ to 5′ or more in length. As an example, typical garden shovels are available in a variety of sizes from that of a small hand shovel of perhaps 8″ to 12″ in overall length, to long digging shovels, measuring as much as 4′ to 5′ or more in overall length, with the user's selection of shovel size dependent on the job or task that is to be performed. To that end, size and option configurations are envisioned with the present invention.

The implement can be manufactured using a variety of materials. It is envisioned that the shaft materials in FIG. 1, items 2, 3 and 7, will be strong, lightweight and durable—Examples of shaft materials, not limited to steel, metal alloy, wood, plastic, fiberglass or graphite and the like. Depending on the materials used, shafts may be of solid or hollow construction—Grips, FIG. 1 items 4, 5 and 6, to be generally constructed of materials that will enhance grip capability, typically of rubber, foam, cloth or other suitable material(s). Though not an essential part of the implement, the inclusion of grips in this and other embodiments of the implement are thought to provide enhanced grip, control and comfort. The arrowhead section of the implement, considered to be the most vital and indispensable part of the invention, may be manufactured using a variety of materials. It is envisioned the arrowhead materials will be strong, lightweight, and durable—Examples of arrowhead materials, not limited to metal, metal alloy or ceramic may be used. Furthermore, the arrowhead portion of the implement may be crafted or fashioned from rolled, pressed, forged or investment cast processing.

The foregoing description of embodiments of the invention has been presented for purposes of illustration and description. It is not intended to be exhaustive or to limit the invention to the precise form disclosed, and obviously many modifications and variations are possible in light of the aforementioned teachings. The embodiments were chosen and described in order to best explain the principles of the invention and its practical application to thereby enable one skilled in the art to best utilize the invention in various embodiments and with various modifications suited to the particular use contemplated. The present invention is, of course, in no way restricted to the specific disclosure of the specification and drawing(s) but also encompasses any modifications within the scope of the hereto appended claims.

What is claimed is:

1. An implement used to penetrate soil and soil barriers to loosen and cultivate soil comprising:
an elongated vertical shaft having an upper section, middle section and lower section forming a longitudinal axis;
vertically mounted grips installed at the upper section and middle section of the elongated vertical shaft;
a plurality of circumferential-spaced triangular blades perpendicularly affixed to the lower section of the elongated vertical shaft forming an arrowhead-shaped cultivating head terminating in a pointed end;

2. An implement according to claim 1 further comprising a transverse handle that is perpendicularly affixed to the upper section of the elongated vertical shaft with grips on either end of the transverse handle.

3. An implement according to claim 1 further comprising a transverse handle that is perpendicularly affixed to the upper section of the elongated vertical shaft with grips on either end of the transverse handle and a lateral member and footrest perpendicularly affixed to the lower section of the elongated vertical shaft, slightly above the arrowhead-shaped cultivating head.

4. A method of cultivating soil or soil that has one or more soil barriers present, in preparation of planting plants, seedlings or seed;
using a cultivation implement comprising an elongated vertical shaft with grips located in the upper and middle sections of the elongated vertical shaft, and terminating in an arrowhead cultivation head, said method comprising the steps of:
thrusting said implement towards area to be cultivated, piercing the arrowhead cultivating head into said soil, thereby cutting into and through said soil barrier(s);
applying downward force on said grips in order to cause arrowhead cultivation head to further pierce through said soil barriers;
firmly grasping twisting, rotating and agitating said vertical grips, thereby causing arrowhead cultivating head to turn, cultivate and churn soil area thereby preparing cultivated soil area;
removing implement from soil to expose cultivated soil area that is ready to receive plant, seedling or seed.

5. A method of cultivating soil according to claim 4 wherein the addition of a transverse handle perpendicularly affixed to the upper section of the elongated vertical shaft with grips on either end of the transverse handle;
allows the user to apply additional downward, twisting, rotating and agitating force on said transverse handle thereby enhancing soil and soil barrier penetration;

6. A method of cultivating soil according to claim 4 wherein the addition of both a transverse handle perpendicularly affixed to the upper section of the elongated vertical shaft with grips on either end of the transverse handle and a lateral member and footrest perpendicularly affixed to the lower section of the elongated vertical shaft, slightly above the arrowhead-shaped cultivating head;
allows the user to apply additional downward, twisting, rotating and agitating force on said transverse handle thereby enhancing soil and soil barrier penetration;
placing a foot on said footrest allows the user to apply significantly greater downward force on said arrowhead cultivation head thereby helping it to pierce hard or compact soil or soil barrier(s) and/or drive said arrowhead cultivation head deeply into the soil.
